(19) United States
(12) Patent Application Publication
(10) Pub. No.: US 2009/0065316 A1
(43) Pub. Date: Mar. 12, 2009

(54) Hydraulic shock absorber for bicycle front fork

(75) Inventor: Hui-Hsiung Chen, Taichung (TW)

Correspondence Address: BACON & THOMAS, PLLC, 625 SLATERS LANE, FOURTH FLOOR, ALEXANDRIA, VA, 22314-1176, US

(73) Assignee: SPINNER INDUSTRY CO., LTD., Taichung (TW)

(21) Appl. No.: 11/987,943

(22) Filed: Dec. 6, 2007

(30) Foreign Application Priority Data
Sep. 7, 2007 (TW) 96215098

(51) Int. Cl. F16F 9/34

(52) U.S. Cl. 188/322.14

(57) ABSTRACT

A hydraulic shock absorber for use in a bicycle front fork include a retractable tube set containing hydraulic fluid, a locking mechanism mounted inside the retractable tube set, and an adjustment mechanism mounted on a top side of the retractable tube set and controllable to lock out and open a hydraulic fluid passage in the locking mechanism for transient pressure relief, assuring riding comfort.

### BACKGROUND OF THE INVENTION

1. Field of the Invention

The present invention relates generally to the front fork of a bicycle and more specifically, to a hydraulic shock absorber for bicycle front fork.

2. Description of the Related Art

FIG. 1 illustrates a hydraulic damping structure used in a front fork of a bicycle according to a design of the prior art, which allows the user to adjust the flow rate of a hydraulic fluid 2 in the front fork 1, thereby achieving the desired damping effect.

The aforesaid prior art design comprises an upper tube 3, a hydraulic fluid 2 filled in the upper tube 3, and a flow speed control mechanism that is comprised of a check valve 4 and an adjustment control set 5. The check valve 4 is fixedly mounted inside the upper tube 3, having an orifice 4a and a tapered inner surface portion 4b that has a diameter gradually increasing from the top side toward the bottom side. The adjustment control set 5 comprises a plug 5a fastened to the top end of the upper tube 3, an adjustment knob 56 mounted on the outside of the plug 6a, a stopper 5d for stopping the orifice 4a, and a control rod 5c, which has its top end fastened to the adjustment knob 56 by a screw joint and its bottom end inserted through the plug 5a and the orifice 4a of the check valve 4 and then fixedly mounted with the stopper 5d. The stopper 5d has a tapered outer surface 5e fitting the tapered inner surface portion 4b.

When rotating the adjustment knob 5b clockwise or counter-clockwise, the control rod 5c is axially moved upwards or downwards relative to the upper tube 3. When lifting the control rod 5c, the tapered outer surface 5a is moved toward the tapered inner surface portion 4b. On the contrary, when lowering the control rod 5c, the tapered outer surface 5e is moved away from the tapered inner surface portion 4b. By means of controlling the gap between the tapered inner surface portion 4b of the check valve 4 and the tapered outer surface 5e of the stopper 5d, the flowing speed and amount of the hydraulic fluid 2 through the gap between the tapered inner surface portion 4b of the check valve 4 and the tapered outer surface 5e of the stopper 5d is relatively controlled to achieve the desired damping effect.

The aforesaid prior art design is workable. However, simply using the adjustment knob 5b to move the control rod 5c and to further control the gap between the tapered inner surface portion 4b and the tapered outer surface 5e cannot accurately control the flowing speed and amount of the hydraulic fluid 2. Therefore, an improvement in this regard is necessary. Further, when the tapered inner surface portion 4b and the tapered outer surface 5e are tightly attached to each other to lock out the hydraulic fluid 2, the transient impact produced during running of the bicycle over an uneven road surface (for example, a cavity on the road) may act on the internal parts of the front fork 1. Frequently impacting the internal parts of the front fork 1 will cause disconnection of the parts or damage to the parts.

Therefore, it is desirable to provide a hydraulic shock absorber for bicycle front fork that eliminates the aforesaid drawback.

### SUMMARY OF THE INVENTION

The present invention has been accomplished under the circumstances in view. It is one objective of the present invention to provide a hydraulic shock absorber for a bicycle front fork, which presents loosening of the parts of the front fork due to rush flow of the hydraulic fluid during a lockout mode, assuring riding comfort.

To achieve this objective of the present invention, the hydraulic shock absorber for bicycle front fork comprises a retractable tube set, a locking mechanism, and an adjustment mechanism.

The retractable tube set comprises an upper tube, hydraulic fluid filled in the upper tube, a bottom tube sleeved onto the upper tube and axially movable relative to the upper tube, and a damper disposed in a bottom side of the upper tube for squeezing the hydraulic fluid.

The locking mechanism is fixedly mounted in the upper tube below the fluid level of the hydraulic fluid in the upper tube to divide an inside space of the upper tube into an upper fluid chamber and a lower fluid chamber for receiving the damper. The locking mechanism comprises an inner tube having a bottom end fastened to a part of the upper tube, a valve block, which is fixedly mounted in the inner tube and provided with a first flow passage in communication with the upper fluid chamber and the lower fluid chamber, at least one return hole disposed in communication with the upper fluid chamber and the lower fluid chamber, at least one through hole in communication with the first flow passage and the upper fluid chamber, an inner thread in the top side of the first flow passage, and a neck portion in the first flow passage below the inner thread, a piston movably disposed in the first flow passage of the valve block, and a first spring for biasing the piston toward the lower fluid chamber.

The adjustment mechanism comprises a rotary knob, a block member mounted on the top side of the upper tube and rotatable by the rotary knob relative to the upper tube and having two downwardly extending bottom rods, a control member, which has two top locating notches respectively coupled to the bottom rods of the block member for allowing synchronous rotation of the control member with the block member and the rotary knob, a neck disposed near a bottom side thereof, a head connected with the neck of the control member and contactable with the neck portion of the valve block, and an outer thread located above the neck and threaded into the inner thread of the valve block.

When rotating the rotary knob in one direction, the head of the control member is forced into contact with the neck portion of the valve block to block the first flow passage. On the contrary, when rotating the rotary knob in the reversed direction, the head of the control member is moved away from the neck portion of the valve block to open the first flow passage for allowing the hydraulic fluid to pass through the first flow passage.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a sectional view of a bicycle front fork according to a design of prior art;

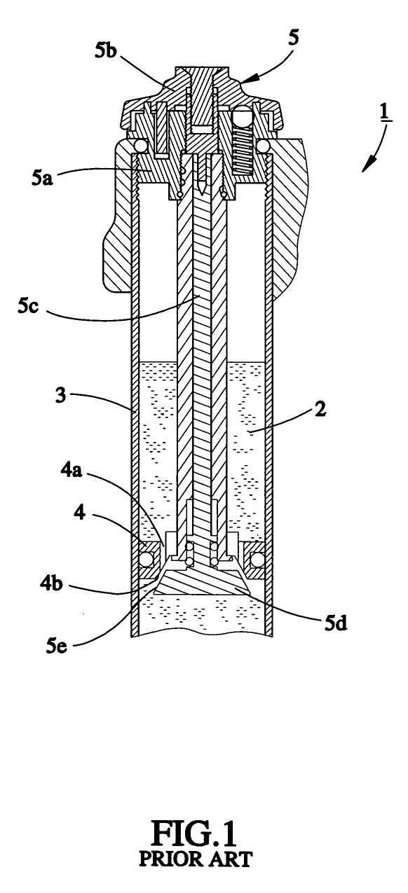

FIG. 2 is a sectional view of a hydraulic shock absorber according to an exemplary embodiment of the present invention;

FIG. 3 is an exploded view of a part of the hydraulic shock absorber according to the present invention;

FIG. 4 is a schematic sectional view showing the hydraulic shock absorber used in a bicycle front fork according to the present invention;

FIG. 5 is a schematic drawing of the present invention, showing the hydraulic shock absorber in the lockout position and not in action;

FIG. 6 is a schematic drawing of the present invention, showing the hydraulic shock absorber in the lockout position and the piston moved by an external pressure;

FIG. 7 is a schematic drawing of the present invention, showing the hydraulic shock absorber in the open position and the piston moved by an external pressure, and

FIG. 8 is a schematic drawing of the present invention, showing the hydraulic shock absorber in the open position but the piston not in action.

### DETAILED DESCRIPTION OF THE INVENTION

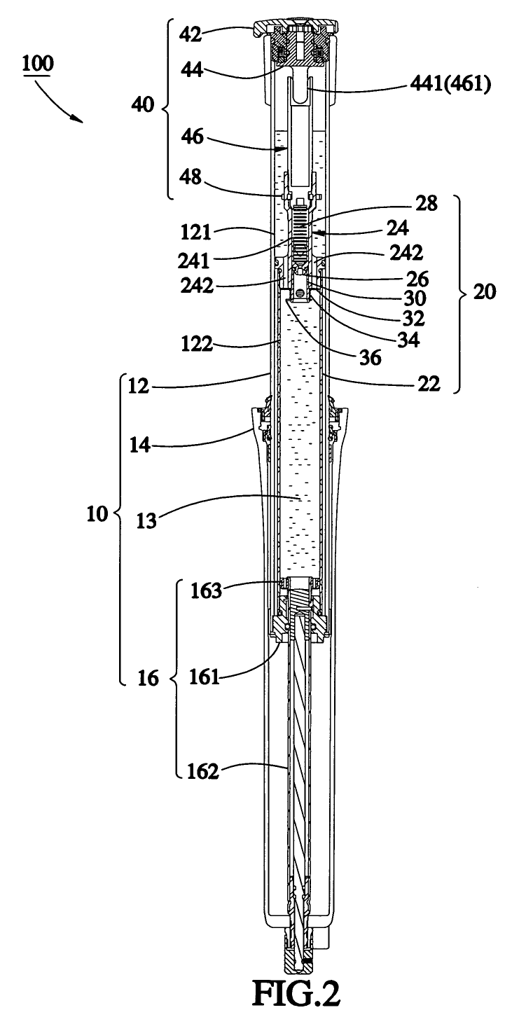

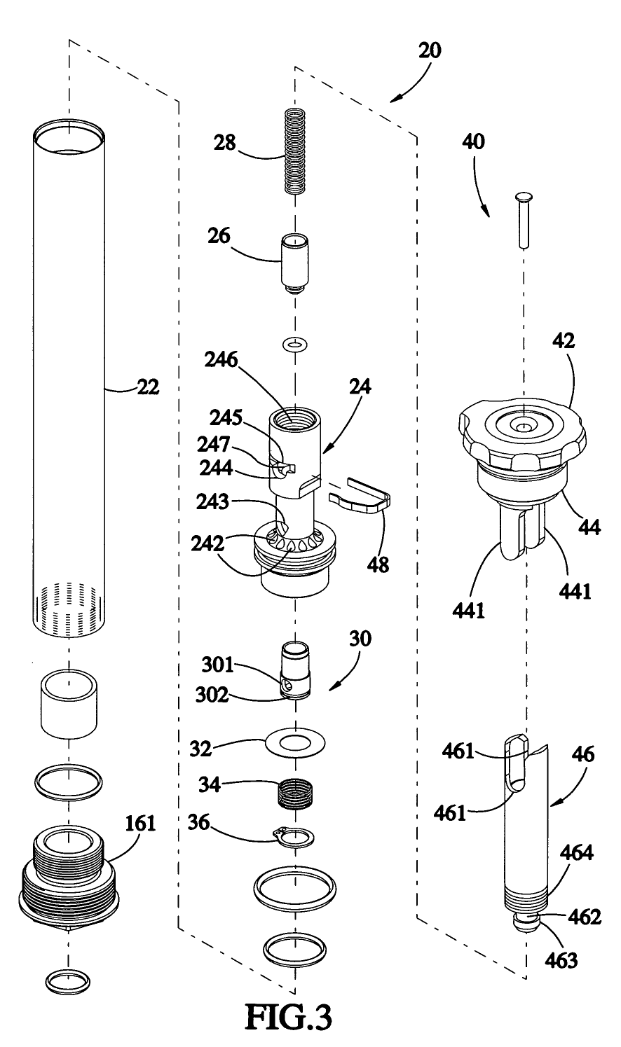

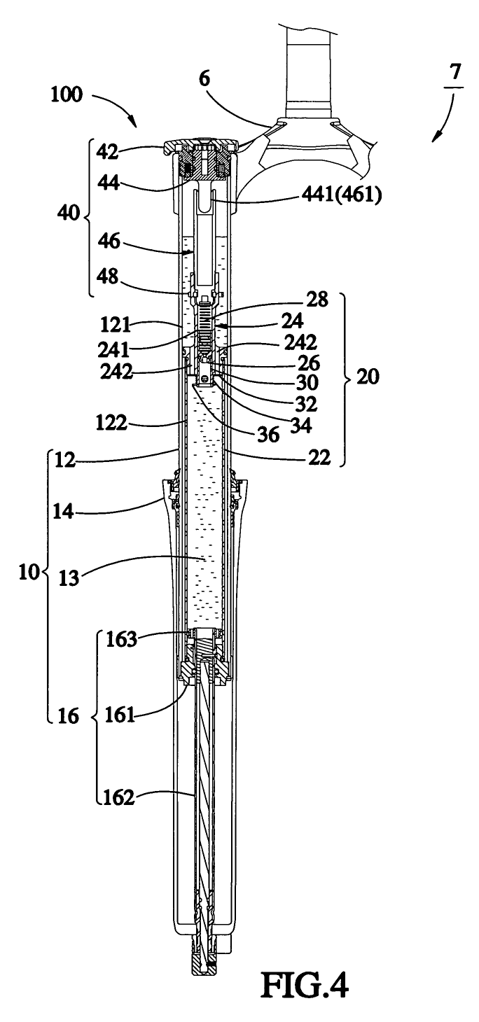

Referring to FIGS. 2-4, a bicycle front fork 7 comprises a fork crown 6, and two hydraulic shock absorbers 100 bilaterally and vertically fastened to the fork crown 6 (only one hydraulic shock absorber 100 is shown in FIG. 4). The hydraulic shock absorber 100 comprises a retractable tube set 10, a locking mechanism 20, and an adjustment mechanism 40.

The retractable tube set 10 is comprised of an upper tube 12, a bottom tube 14, a damper 16, and hydraulic fluid 13 filled in the upper tube 12. The bottom tube 14 is sleeved onto the upper tube 12 from the bottom side, and axially movable relative to the upper tube 12 to adjust the length of the retractable tube set 10. The damper 16 is comprised of a plug 161, a piston rod 162, and a damping piston 163. The plug 161 is fixedly fastened with its bottom end to the inside of the bottom end of the upper tube 12. The piston rod 162 is suspending in the bottom tube 14, having its bottom end fixedly connected to the bottom end of the bottom tube 14 and its top end inserted through the plug 161 into the inside of the upper tube 12. The damping piston 163 is fixedly connected to the top end of the piston rod 162 to stop the hydraulic fluid 13 in the upper tube 12. When the bicycle is moving over an uneven road surface, the upper tube 12 and the bottom tube 14 are moved relative each other, and the piston rod 162 is moved with the bottom tube 14 up and down relative to the upper tube 12, causing the damping piston 163 to move the hydraulic fluid 13.

The locking mechanism 20 is disposed below the fluid level of the hydraulic fluid 13, comprised of an inner tube 22, a valve block 24, a piston 26, a first spring 28, a socket 30, a valve flap 32, a second spring 34, and a retainer ring 36.

The inner tube 22 has its internally threaded bottom end fastened to the top end of the plug 161 and its internally threaded top end threaded onto the valve block 24. The bottom end of the inner tube 22 receives the piston rod 162 of the damper 16.

The valve block 24 is mounted in the upper tube 12 to divide the inside space of the upper tube 12 into an upper fluid chamber 121 and a lower fluid chamber 122. The valve block 24 comprises a first flow passage 241 for guiding the hydraulic fluid 13 from the lower fluid chamber 122 to the upper fluid chamber 121, a plurality of return holes 242 for guiding the hydraulic fluid 13 from the upper fluid chamber 121 to the bottom fluid chamber 122, two symmetrical through holes 243 and two symmetrical guide holes 244 respectively disposed in communication with the first flow passage 241 and the upper fluid chamber 121. The width of the opening of the through holes 243 increases gradually from the bottom side toward the top side thereof. The piston 26 is moveably disposed in the first flow passage 241 of the valve block 24 so as to close/open the through holes 243, thereby controlling the flowing of the hydraulic fluid 13. The valve block 24 further comprises two locating grooves 245 formed on the periphery and located in communication with the guide holes 244, an inner thread 246 formed on the upper part of the inside wall of the first flow passage 241, and a neck portion 247 on the upper part of the inside wall of the first flow passage 241 at the bottom side of the inner thread 246. The piston 26 is mounted in and movable along the first flow passage 241 of the valve block 24.

The first spring 28 is mounted in the first flow passage 241 of the valve block 24 and supported on the piston 26, having its bottom side stopped against the piston 26 and its top side stopped against the adjustment mechanism 40. The first spring 28 imparts a downward pressure to the piston 26, causing the piston 26 to block the through holes 243.

The socket 30 is mounted in and movable along the first flow passage 241 of the valve block 24, comprising two through holes 301 transversely cut through the periphery and aligned at two opposite sides near the bottom side of the socket 30, and a locating groove 302 extending around the periphery at the bottom side of the through holes 301.

The valve flap 32 is disposed on the periphery of the socket 30 at the bottom side of the valve block 24 and movable by the hydraulic fluid 13 in the lower fluid chamber 122. Further, the valve flap 32 fully blocks the return holes 242 when it receives no external pressure.

The second spring 34 is sleeved onto the socket 30.

The retainer ring 36 is fastened to the locating groove 302 to support the second spring 34 on the socket 30 against the valve flap 32. When the pressure in the upper fluid chamber 121 surpasses the pressure in the bottom fluid chamber 122, the hydraulic fluid 13 is forced to flow from the upper fluid chamber 121 through the return holes 242 into the lower fluid chamber 122. When the valve flap 32 is forced away from the return holes 242 by the hydraulic fluid 13 to compress the second spring 34, the hydraulic fluid 13 is allowed to flow from the upper fluid chamber 121 through the through holes 301 into the lower fluid chamber 122.

The adjustment mechanism 40 is comprised of a rotary knob 42, a block member 44, a control member 46, and a clamping spring strip 48.

The rotary knob 42 is affixed to the block member 44 with a screw (not shown) and disposed at the top side of the upper tube 12. The block member 44 is rotatable with the rotary knob, having two bottom rods 441 downwardly extending from its bottom side and arranged in parallel.

The control member 46 comprises two top locating notches 461 respectively coupled to the bottom rods 441 of the block member 44 for allowing synchronous rotation of the control member 46 with the block member 44 and the rotary knob 42, a neck 462 disposed near the bottom side, a head 463 disposed at the bottom side for contacting the neck portion 247 of the valve block 24, and an outer thread 464 extending around the periphery above the neck 462 and threaded into the inner thread 246 of the valve block 24.

The clamping spring strip 48 is fastened to the locating grooves 245 of the valve block 24 to clamp the neck 462 of the control member 46. The vertical width of the neck 462 is greater than the vertical width of the clamping spring strip 48 so that the control member 46 is vertically movable relative to the clamping spring strip 48 and the valve block 24 within a limited range corresponding to the vertical width of the neck 462.

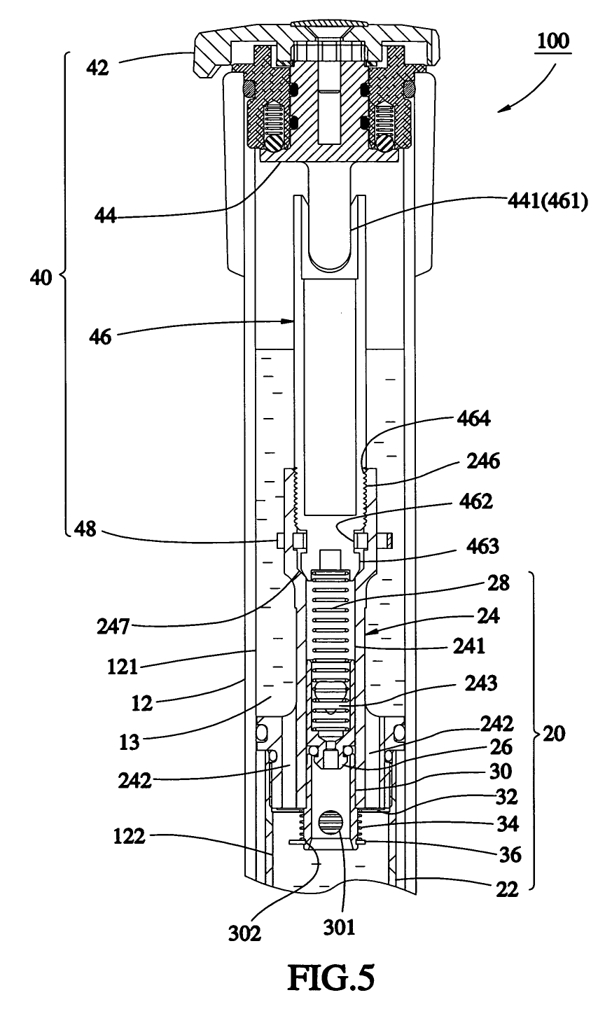

Referring to FIG. 5, the user can rotate the rotary knob 42 of the adjustment mechanism 40 to adjust the cross sectional area of the first flow passage 241 that is blocked by the adjustment mechanism 40 and to further adjust the gap between the neck portion 247 of the valve block 24 and the head 463 of the control member 46, thereby regulating the flow rate of the hydraulic fluid 13 flowing from the lower fluid chamber 122 into the upper fluid chamber 121. When the neck portion 247 of the valve block 24 is in full contact with the head 463 of the control member 46, the first flow passage 241 is blocked, and at this time the hydraulic shock absorber 100 is locked out and provides no damping effect. Under this operation mode, the pedaling efficiency of the bicycle is enhanced, and the bicycle is suitable for running on a slope or smooth road surface.

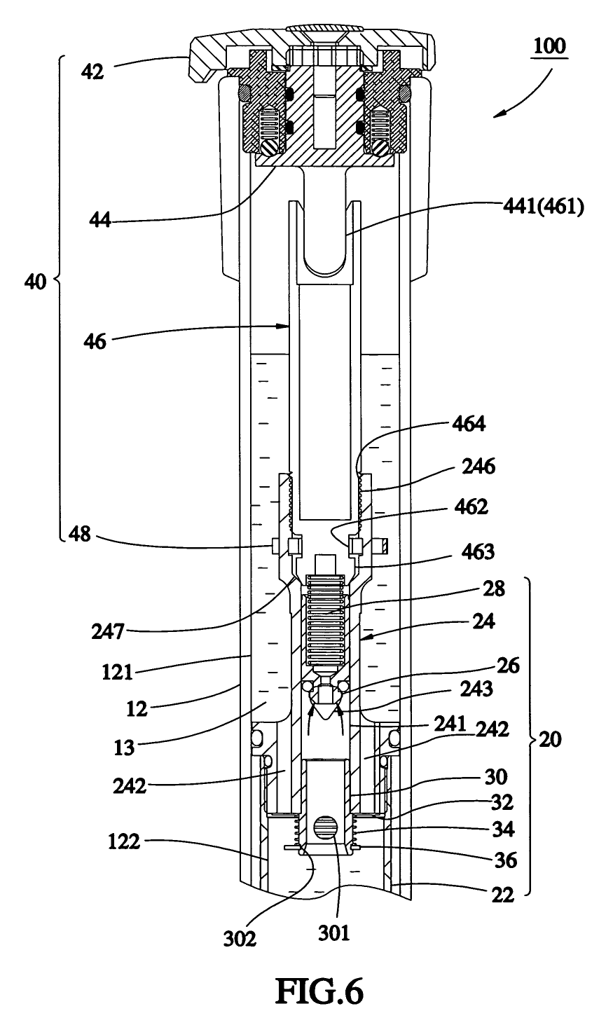

Referring to FIG. 6, when the bicycle is running over a protruding object, cavity, or any obstacle on the road, the piston 26 is moved subject to the change of the internal pressure of the lower fluid chamber 122, causing the first spring 28 to absorb or lessen the impact. When the hydraulic fluid 13 in the lower fluid chamber 122 forces the piston 26 to the extent that the piston 26 cannot block the through holes 243 of the valve block 24, the hydraulic fluid 13 flows through the through holes 243 of the valve block 24 into the upper fluid chamber 121 to relieve the pressure, lowering the chance of loosening of the parts upon the occurrence of a transient impact and preventing transmission of vibration waves to the rider of the bicycle. When passed over the obstacle on the road, the first spring 28 pushes the piston 26 backwardly to its former position to block the through holes 243 of the valve block 24 again (see FIG. 5), thereby terminating the aforesaid pressure relief effect.

Although the hydraulic shock absorber 100 is set in the lock out status, it still can produce a transient pressure relief effect when encounters an impact as the bicycle is running over an uneven road surface, preventing loosening of the internal parts of the front fork 7 or impact damage to the internal parts of the front fork 7, and assuring riding comfort.

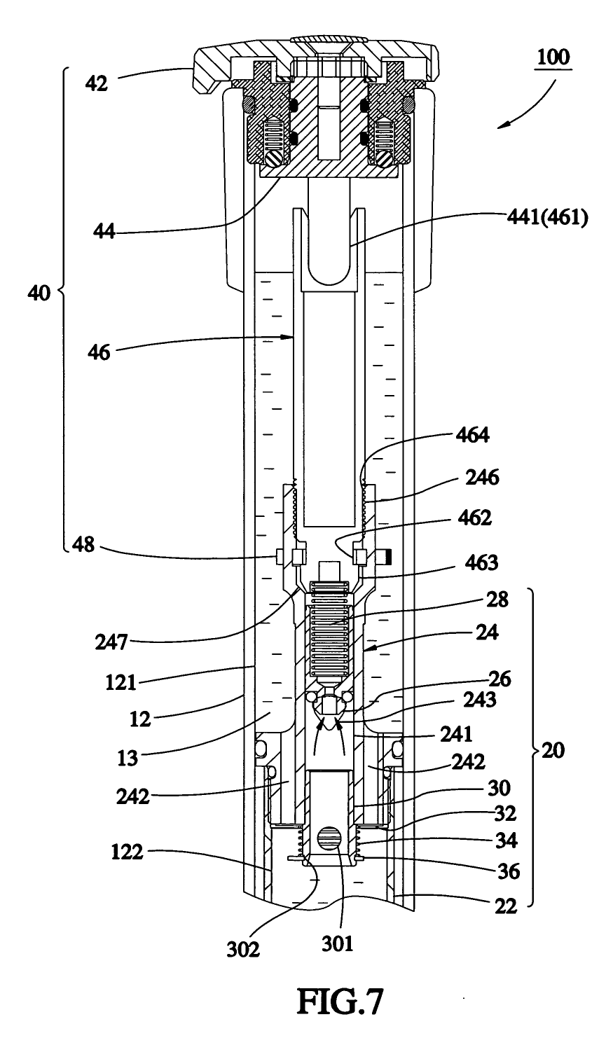

Referring to FIG. 7, when the rider of the bicycle operates the rotary knob 42 of the adjustment mechanism 40 to rotate the control member 46 backwards and to produce a gap between the head 463 of the control member 46 and the neck portion 247 of the valve block 24, i.e., to open the first flow passage 241, the hydraulic shock absorber 100 is unlocked and can provide a damping effect. Under this mode, the hydraulic shock absorber 100 fits for a long distance riding on an uneven road. When the bicycle is running over a protrusion on the road at this time, the piston 26 is forced upwards by the hydraulic fluid 13, and the hydraulic fluid 13 flows from the lower fluid chamber 122 into the upper fluid chamber 121 through the gap between the head 463 of the control member 46 and the neck portion 247 of the valve block 24 to relieve the pressure. Because the through holes 243 of the valve block 24 have a width gradually increasing from the bottom side toward the top side, the flowing speed and amount of the hydraulic fluid 13 entering the upper fluid chamber 121 via the gap between the head 463 of the control member 46 and the neck portion 247 of the valve block 24 is gradually increased during upstroke of the piston 26. By means of the effect of the material property of the viscous hydraulic fluid 13 and the feature of gradually increasing flowrate of the hydraulic fluid 13 into the upper fluid chamber 21, the desired shock absorbing effect is achieved.

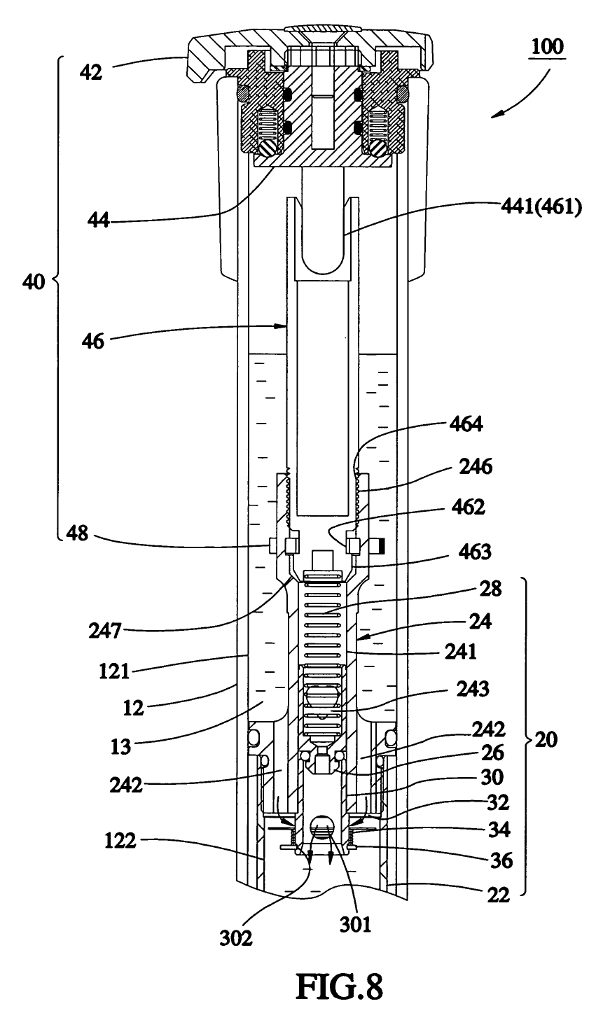

Referring to FIG. 8, when the bicycle moved over a terrain, the first spring 28 pushes the piston 26 backwards to block the through holes 243 of the valve block 24, terminating the pressure relief effect. Further, when the internal pressure of the upper fluid chamber 121 surpasses the internal pressure of the lower fluid chamber 122, the hydraulic fluid 13 will flow through the return holes 242 to push the valve flap 32 away from the return holes 242, allowing the hydraulic fluid 13 to flow from the upper fluid chamber 121 through the through holes 301 of the socket 30 into the lower fluid chamber 122 to balance the pressure between the upper fluid chamber 121 and the lower fluid chamber 122.

As stated above, the hydraulic shock absorber for bicycle front fork allows the user to adjust the elevational position of the control member by means of rotating the rotary knob. When the control member is lowered, the head of the control block is forced into close contact with the neck portion of the first flow passage of the valve block to block the first flow passage. When the control member is lifted, the head of the control block is moved away from the neck portion of the first flow passage of the valve block to open the first flow passage for enabling the hydraulic fluid to pass through the locking mechanism.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydraulic shock absorber for a bicycle front fork, comprising:
a retractable tube set including an upper tube, hydraulic fluid filled in said upper tube, a bottom tube sleeved onto said upper tube and axially movable relative to said upper tube, and a damper disposed in a bottom side of said upper tube for squeezing said hydraulic fluid;
a locking mechanism fixedly mounted in said upper tube below the fluid level of said hydraulic fluid in said upper tube to divide an inside space of said upper tube into an upper fluid chamber and a lower fluid chamber, said locking mechanism including:
an inner tube having a bottom end thereof fastened to a part of said damper in said upper tube;
a valve block fixedly mounted in said inner tube and provided with a first flow passage in communication with said upper fluid chamber and said lower fluid chamber, at least one return hole in communication with said upper fluid chamber and said lower fluid chamber, at least one through hole in communication with said first flow passage and said upper fluid chamber, an inner thread in a top side of said first flow passage, and a neck portion in said first flow passage below said inner thread;
a piston moveably disposed in said first flow passage of said valve block; and
a first spring for biasing said piston toward said lower fluid chamber; and
an adjustment mechanism including:
a rotary knob;
a block member mounted on the top side of said upper tube and rotatable by said rotary knob relative to said upper tube, said block member having two downwardly extending bottom rods;
a control member having two top locating notches respectively coupled to the bottom rods of said block member for allowing synchronous rotation of said control member with said block member and said rotary knob, a neck disposed near a bottom side thereof, a head connected with the neck of said control member and contactable with said neck portion of said valve block, and an outer thread located above said neck and threaded into the inner thread of said valve block;
wherein when rotating said rotary knob in one direction, said head of said control member is forced into contact with said neck portion of said valve block to block said first flow passage; when rotating said rotary knob in the reversed direction, said head of said control member is moved away from said neck portion of said valve block to open said first flow passage for allowing said hydraulic fluid to pass through said first flow passage.

2. The hydraulic shock absorber as claimed in claim 1, wherein said damper comprises:
a plug fixedly fastened to the bottom side of said upper tube;
a piston rod having a bottom end fixedly connected to a bottom side of said bottom tube and a top end inserted through said plug into said upper tube; and
a damping piston fixedly connected to the top end of said piston rod.

3. The hydraulic shock absorber as claimed in claim 1, wherein said at least one through hole of said valve block each has a width vertically gradually increasing from a bottom side toward a top side thereof; said piston of said locking mechanism is movable in said valve block to block or open the at least one through hole of said valve block and to further control the flowing of said hydraulic fluid.

4. The hydraulic shock absorber as claimed in claim 1, wherein said valve block further comprises two guide holes in communication with said first flow passage and said upper fluid chamber, and two locating grooves in communication with said guide holes respectively; said adjustment mechanism further comprises a clamping spring strip fastened to said locating grooves of said valve block and clamped on the neck of said control member.

5. The hydraulic shock absorber as claimed in claim 4, wherein the neck of said control member has a vertical width greater than the vertical width of said clamping spring strip, such that said clamping spring strip is movable relative to said control member along said neck.

6. The hydraulic shock absorber as claimed in claim 1, wherein said locking mechanism further comprises:
a socket mounted in and movable along said first flow passage of said valve block, said socket having at least one through hole disposed near a bottom side thereof, and a locating groove extending around a periphery of the bottom side of said socket;
a valve flap disposed on the periphery of said socket and movable by said hydraulic fluid in said lower fluid chamber to block and open said at least one return hole of said valve block;
a retainer ring fastened to the locating groove of said socket; and
a second spring sleeved onto said socket and stopped between said retainer ring and said valve flap.
